(19) United States
(12) Patent Application Publication
(10) Pub. No.: US 2005/0046616 A1
(43) Pub. Date: Mar. 3, 2005

(54) Radio communication apparatus and radio communication method

(76) Inventors: Hirotomo Sai, Yokohama (JP); Hiroyasu Otsubo, Yokohama (JP); Susumu Matsui, Machida (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/879,043

(22) Filed: Jun. 30, 2004

(30) Foreign Application Priority Data
Jun. 30, 2003 (JP) 2003-186659

(51) Int. Cl. G01C 21/34

(52) U.S. Cl. 342/360; 701/213; 342/357.06

(57) ABSTRACT

A radio communication apparatus includes a first communication unit for transmitting and receiving a nondirectional communication wave, a second communication unit for transmitting and receiving a directional communication wave and a transmitted/received data control unit for controlling transmission and reception of the low-rate data through the first communication unit and the high-rate data through the second communication unit, thereby even under a narrow environment where a number of the radio communication apparatuses transmit and receive a large amount of the high-rate data to and from one another in a short space, transmitting and receiving an image without interruption and quality deterioration.

The present application claims priority from Japanese application JP-A-2003-186659 filed on Jun. 30, 2003, the content of which is hereby incorporated by reference into this application.

### BACKGROUND OF THE INVENTION

1. Field of the Invention

The present invention relates to a radio communication apparatus and a radio communication method, or in particular to a radio communication apparatus and a radio communication method in which a number of the radio communication apparatuses transmit and receive information directly to and from each other by the P2P (peer to peer) communication in a short range which poses the problem of interference between radio waves.

2. Description of the Related Art

The global radio communication over a wide range using the radio wave between such apparatuses as radio sets, TV sets or mobile phones is a common practice. These apparatuses use the nondirectional radio wave and therefore can send the radio wave over a wide range. In the case where base stations are concentrated within a given range, however, the problem of the interference between radio waves and conflicts between signals is encountered.

In a narrow environment in which radio waves interfere with each other, therefore, a system configuration comprising one fixed station (server) and a plurality of apparatuses (clients) is employed in which the communication is conducted between the apparatuses through the fixed station.

The communication between a plurality of apparatuses is conducted by switching the communication frequency at high speed in an available communication frequency band or by using the spread spectrum technique to secure a plurality of communication channels and thus to avoid the interference between radio waves and conflicts between signals. This communication in a narrow environment uses CDMA, Bluetooth, IEEE802.11b, etc. as a communication scheme.

In contrast to the nondirectional radio communication, a radio optical communication is available with the laser, infrared light and the like having the directivity. The use of these communication means has the advantages that the communication is made possible with the other party at a farther place with a limited amount of power and a high resistance to noises. Also in a crowded environment, the probability of signal conflicts is so low that efficient communication is possible. The directional communication is impossible, however, without overcoming the problem of the requirement to correctly recognize the position of the other party of communication.

The information on the position of a given radio communication apparatus is obtained by the method using the GPS (global positioning system) receiving the signals from a satellite or the method disclosed in JP-A-2001-83231, for example, in which the distance to the particular radio communication apparatus is calculated by measuring the radio wave propagation time between a plurality of radio communication apparatuses.

In a narrow environment including a home network in which a number of apparatuses frequently transmit and receive a large amount of high-rate data such as digital video data in a short range, and the interference between radio waves is a problem, the communication using the nondirectional radio wave causes a heavy communication traffic and deteriorates the throughput. As a result, the problem is encountered that the image disappears midway or only a dynamic image of lower quality can be transmitted or received.

### SUMMARY OF THE INVENTION

The object of this invention is to provide a radio communication apparatus and a radio communication method in which no image disappears midway and a dynamic image of high image quality can be transmitted and received in a narrow environment where a large amount of high-rate data are transmitted and received in a short range between a number of the radio communication apparatuses.

In order to achieve this object, according to a first aspect of the invention, there is provided a radio communication apparatus comprising a first communication unit for transmitting and receiving a nondirectional communication wave, a second communication unit for transmitting and receiving a directional communication wave, and a transmission/receiving data control unit for performing the control operation in such a manner as to transmit and receive low-rate data through the first communication unit and high-rate data through the second communication unit.

According to a second aspect of the invention, there is provided a radio communication apparatus comprising a first communication unit for transmitting and receiving the nondirectional communication wave, a second communication unit for transmitting and receiving the directional communication wave, a local radio communication apparatus position information accession unit for detecting the information on the position of a local radio communication apparatus, a remote radio communication apparatus position information accession unit for detecting the information on the position of the radio communication apparatus of the other party of communication, a transmission/receiving direction control unit for controlling the direction in which the directional communication wave is transmitted and received, based on the information on the position of the local radio communication apparatus and the information on the position of the radio communication apparatus of the other party, and a transmitted/received data control unit for performing the control operation in such a manner as to transmit and receive the low-rate data through the first communication unit and the high-rate data through the second communication unit.

According to a third aspect of the invention, there is provided a radio communication apparatus wherein the local radio communication apparatus position information accession unit receives the radio wave from a communication satellite.

According to a fourth aspect of the invention, there is provided a radio communication apparatus wherein the data are transmitted and received by switching between the nondirectional communication wave and the directional communication wave.

According to a fifth aspect of the invention, there is provided a radio communication apparatus wherein the data are transmitted and received using both the nondirectional communication wave and the directional communication wave at the same time.

According to a sixth aspect of the invention, there is provided a radio communication method for the radio communication apparatus comprising a first communication unit for transmitting and receiving the nondirectional communication wave and a second communication unit for transmitting and receiving the directional communication wave, wherein the low-rate data are transmitted and received by the first communication unit and the high-rate data by the second communication unit.

According to a seventh aspect of the invention, there is provided a radio communication method for the radio communication apparatus comprising a first communication unit for transmitting and receiving the nondirectional communication wave and a second communication unit for transmitting and receiving the directional communication wave, comprising the steps of controlling the direction of transmitting and receiving selected one of the directional radio wave and the directional radio optical wave, based on the information on the position of the local radio communication apparatus and the information on the position of the radio communication apparatus of the other party, transmitting/receiving the low-rate data through the first communication unit, and transmitting/receiving the high-rate data through the second communication unit.

According to an eighth aspect of the invention, there is provided a radio communication method comprising the step of detecting the information on the position of the local radio communication apparatus by receiving the radio wave from the communication satellite.

According to a ninth aspect of the invention, there is provided a radio communication method comprising the step of transmitting and receiving the data by switching between the nondirectional communication wave and the directional communication wave.

According to a tenth aspect of the invention, there is provided a radio communication method comprising the step of transmitting and receiving the data using both the nondirectional communication wave and the directional communication wave at the same time.

The above and other objects, features and advantages will be made apparent by the detailed description taken in conjunction with the accompanying drawings.

### BRIEF DESCRIPTION OF THE DRAWINGS

FIG. 1 is a block diagram showing a radio communication apparatus according to an embodiment of the invention.

FIG. 2 is a diagram showing the data transmitted from a first radio communication apparatus to a second radio communication apparatus and the same transmitted data received by the first radio communication apparatus from the second radio communication apparatus.

FIG. 3 is a diagram for explaining the accession of the information on the position of a local radio communication apparatus among a number of radio communication apparatuses according to an embodiment of the invention.

FIG. 4 is a diagram showing the communication conditions of a narrow environment in which a large amount of high-rate data are transmitted and received in a short range between a number of radio communication apparatuses.

### DETAILED DESCRIPTION OF THE EMBODIMENTS

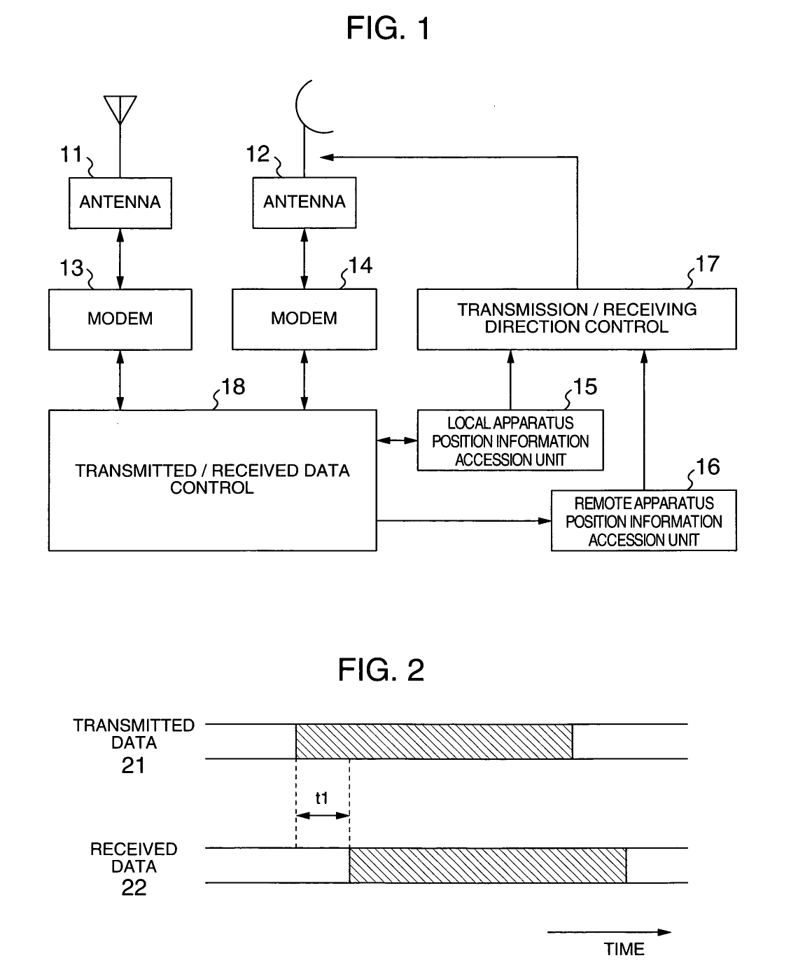

Embodiments of the invention are explained below with reference to the accompanying drawings. FIG. 1 is a block diagram showing a radio communication apparatus according to an embodiment of the invention. In FIG. 1, reference numerals 11, 12 designate antennas for transmitting and receiving the communication wave, numerals 13, 14 modulator/demodulators (hereinafter referred to as the modem) for demodulating the communication wave received and modulating the communication wave to be transmitted, numeral 15 a local radio communication apparatus position information accession unit for detecting the information on the position of the local radio communication apparatus, numeral 16 a remote radio communication apparatus position information accession unit for detecting the information on the position of the other party of communication, numeral 17 a transmission/receiving direction control unit for controlling the direction in which the communication wave is transmitted or received, and numeral 18 a transmitted/received data control unit for distributing the transmitted data and the received data among the appropriate radio communication apparatuses.

In FIG. 1, the antenna 11 receives the nondirectional communication wave, and the modem 13 demodulates the signal from the antenna 11 and inputs the signal to the transmitted/received data control unit 18 as received data. Also, the transmitted data output from the transmitted/received data control unit 18 is modulated by the modem 13 and transmitted on a communication wave through the antenna 11.

In this nondirectional communication, the remote radio communication apparatus position information accession unit 16 obtains the information on the position of the radio communication apparatus of the other party of communication from the transmitted/received data control unit 18, and the local radio communication apparatus position information accession unit 15 notifies the other party of the information on the position of the local radio communication apparatus through the transmitted/received data control unit 18. Based on the information on the position of the remote radio communication apparatus of the other party and the information on the position of the local radio communication apparatus thus obtained, the transmission/receiving direction control unit 17 determines the direction in which the directional communication wave is transmitted or received, and controls the antenna 12 in that particular direction.

With the transmission/receiving direction control unit 17 controlled, a communicating wave received at the antenna 12 is demoduled by the modem 14 to be transferred to the transmitted/received data control unit 18. The output of the transmitted/received control unit 18 is then modulated as communicating data by the modem 14 to be transmitted from the antenna 12, transmitting and receiving the communication data at the antenna 12 with use of the communicating wave having the directivity.

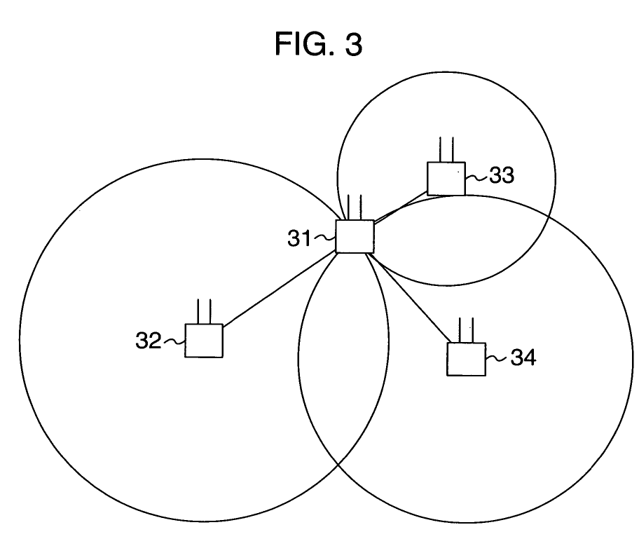

Next, the operation of the local radio communication apparatus position accession unit 15 is explained with reference to FIGS. 2 and 3.

FIG. 3 is a diagram for explaining the accession of the information on the position of the local radio communication apparatus among a number of radio communication apparatuses according to an embodiment of the invention. In FIG. 3, numerals 31, 32, 33, 34 designate radio communication apparatuses. An explanation is given about the manner in which the radio communication apparatus 31 obtains the information on the position thereof.

FIG. 2 is a diagram showing the data transmitted from the radio communication apparatus 31 to the radio communication apparatus 32 and the same data received by the radio communication apparatus 31. In FIG. 2, numeral 21 designates the data transmitted from the radio communication apparatus 31 by nondirectional communication. In FIG. 2, the horizontal direction represents the time elapsed. Numeral 22 designates the transmitted data 21 received and transmitted by the radio communication apparatus 32 in FIG. 3 and received by the radio communication apparatus 31 in FIG. 3. The hatched portions in FIG. 2 indicate the same data.

In the process, assume that t1 is the time delay between the transmitted data 21 and the received data 22, t2 the time delay from the receipt of the transmitted data 21 and transmission of the same data by the radio communication apparatus 32, and c the propagation rate of the communication wave in the nondirectional communication used. Then, the distance r between the radio communication apparatus 31 and the radio communication apparatus 32 in FIG. 3 is expressed by equation (1) below.
r=c×(t1−t2)÷2 (1)
where t1−t2 is the two-way propagation time between the radio communication apparatus 31 and the radio communication apparatus 32, and the one-way propagation time between the radio communication apparatus 31 and the radio communication apparatus 32 is given as (t1−t2) divided by 2.

In similar fashion, the distance between the radio communication apparatuses 31 and 33 and the distance between the radio communication apparatuses 31 and 34 can be determined.

Once the distances between the local radio communication apparatus 31 and at least three radio communication apparatuses come to be known, as shown in FIG. 3, the position of the radio communication apparatus 31 can be determined by use of triangulation.

The local radio communication apparatus position accession unit 15 can obtain the information on the position thereof by receiving the signal from the GPS satellite. In the case where the local radio communication apparatus is a fixed radio communication apparatus, the user can set the position information in advance.

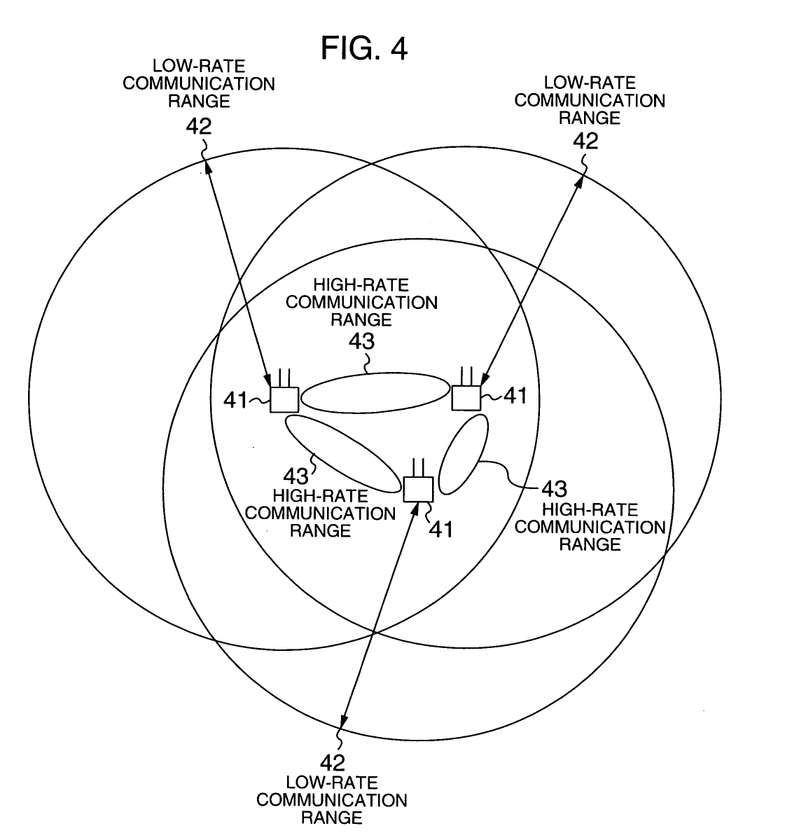

Now, the operation of the transmitted/received data control unit 18 is explained with reference to FIG. 4. FIG. 4 shows the communication conditions in a narrow environment in which a number of radio communication apparatuses transmit and receive a large amount of high-rate data in a short range according to an embodiment of the invention.

In FIG. 4, numerals 41 designate radio communication apparatuses, the true circles designated by numerals 42 represent the range of nondirectional communication, and the elongate ellipses designated by numerals 43 represent the range of directional communication.

As shown in FIG. 4, as long as the ranges 42 for nondirection communication are superposed one on another, the radio waves interfere with each other. Even in the case where the high-speed communication frequency switching or the spread spectrum technique is used, therefore, the data rate of communication is limited.

In view of this, according to an embodiment of this invention, the transmitted/received data control unit 18 controls the data transmitted/received by the nondirectional communication wave to a low rate and the data transmitted/received by the directional communication wave to a high rate. In this way, the nondirectional communication and the directional communication are used alternately by being switched or at the same time. Thus, a large amount of communication data can be transmitted and received at high rate without interruption.

As explained above, the radio communication apparatus according to the embodiments of the invention comprise a local radio communication apparatus position accession unit, wherein the information on the position of each radio communication apparatus is exchanged between the radio communication apparatuses by nondirectional communication. Since the nondirectional communication is made possible in this way, the low-rate data is transmitted/received by nondirectional communication and the high-rate data by directional communication. By alternate or simultaneous use of these two types of communication units, therefore, the radio communication is made possible without any interruption or quality deterioration of a dynamic image in a narrow environment in which a large amount of data are transmitted and received at high rate in a short range between a number of radio communication apparatuses.

It will thus be understood from the foregoing description that according to this invention, a radio communication apparatus and a radio communication method are provided in which the radio communication is possible in a narrow environment in which a large amount of high-rate data are transmitted and received in a short range between a number of radio communication apparatuses, without any interruption or quality deterioration of a dynamic image.

The embodiments of the invention described above are illustrative and not restrictive, and it is apparent to those skilled in the art that various changes and modifications are possible without departing from the spirit of the invention and the scope of the appended claims.

1. A radio communication apparatus comprising:
a first communication unit for transmitting and receiving a nondirectional communication wave;
a second communication unit for transmitting and receiving a directional communication wave; and
a transmitted/received data control unit for controlling a transmission and a reception of low-rate data through the first communication unit and of high-rate data through the second communication unit.

2. A radio communication apparatus comprising:
a first communication unit for transmitting and receiving a nondirectional communication wave;
a second communication unit for transmitting and receiving a directional communication wave;
a local radio communication apparatus position information accession unit for detecting the information on the position of the local radio communication apparatus;
a remote radio communication apparatus position information accession unit for detecting the information on the position of the radio communication apparatus of the other party of communication;
a transmission/receiving direction control unit for controlling a direction of transmitting and receiving the directional communication wave, based on the information on the position of the local radio communication apparatus and the information on the position of the remote radio communication apparatus of the other party; and
a transmitted/received data control unit for controlling the transmission and the reception of the low-rate data through the first communication unit and of the high-rate data through the second communication unit.

3. A radio communication apparatus according to claim 2,
wherein the local radio communication apparatus position information accession unit detects the information on the position of the local radio communication apparatus by receiving the radio wave from a communication satellite.

4. A radio communication apparatus according to claim 1,
wherein the data are transmitted and received by switching between the nondirectional communication wave and the directional communication wave.

5. A radio communication apparatus according to claim 1,
wherein the data are transmitted and received using both the nondirectional communication wave and the directional communication wave at the same time.

6. A radio communication method for a radio communication apparatus including a first communication unit for transmitting and receiving a nondirectional communication wave and a second communication unit for transmitting and receiving a directional communication wave, comprising the steps of:
transmitting and receiving low-rate data through the first communication unit and high-rate data through the second communication unit.

7. A radio communication method for a radio communication apparatus including a first communication unit for transmitting and receiving a nondirectional communication wave and a second communication unit for transmitting and receiving a directional communication wave, comprising the steps of:
controlling a direction of transmitting and receiving the directional communication wave, based on the information on the position of a local radio communication apparatus and the information on the position of a remote radio communication apparatus of the other party; and
transmitting and receiving the low-rate data through the first communication unit and transmitting and receiving the high-rate data through the second communication unit.

8. A radio communication method according to claim 7, comprising the step of:
detecting the information on the position of the local radio communication apparatus by receiving the radio wave from a communication satellite.

9. A radio communication method according to claim 6, comprising the step of:
transmitting and receiving the data by switching between the nondirectional communication wave and the directional communication wave.

10. A radio communication method according to claim 6, comprising the step of:
transmitting and receiving simultaneously the data using both the nondirectional communication wave and the directional communication wave.
